(19) United States
(12) Patent Application Publication
(10) Pub. No.: US 2025/0351805 A1
(43) Pub. Date: Nov. 20, 2025

(54) SENSOR-CONTROLLED BUBBLE EMISSION SYSTEM FOR AQUACULTURE

(71) Applicant: TidalX AI Inc., Mountain View, CA (US)

(72) Inventors: Grace Calvert Young, Mountain View, CA (US); Thomas Robert Swanson, Sunnyvale, CA (US); Riva Gulassa, Sunnyvale, CA (US); Hanumant Singh, Falmouth, MA (US)

(21) Appl. No.: 19/290,204

(22) Filed: Aug. 4, 2025

Related U.S. Application Data
(63) Continuation of application No. PCT/US2024/014150, filed on Feb. 2, 2024.
(60) Provisional application No. 63/483,505, filed on Feb. 6, 2023.

(51) Int. Cl. A01K 61/13; A01K 61/90

(52) U.S. Cl. CPC A01K 61/13; A01K 61/90; A01K 2227/40

(57) ABSTRACT

Methods, systems, and apparatus, including computer programs encoded on computer-storage media, for sensor system controlling bubbler. In some implementations, a method includes obtaining sensor data indicating a condition in a vicinity of a fish pen; comparing the sensor data to one or more thresholds; determining the sensor data satisfies the one or more thresholds; generating a signal configured to cause bubbles in the vicinity of the fish pen; and transmitting the signal to a bubble generating system.

### CROSS-REFERENCE TO RELATED APPLICATIONS

This application is a continuation and claims priority of International Application No. PCT/US2024/014150, filed Feb. 2, 2024, which claims priority of U.S. Provisional Application No. 63/483,505, filed Feb. 6, 2023. The contents of the prior applications are incorporated herein by reference in their entirety.

### FIELD

This specification generally relates to aquaculture and techniques for improving aspects of aquaculture.

### BACKGROUND

Aquaculture typically involves growing fish or other marine animals for human consumption. In the case of fish, aquaculture systems can include pens that store one or more fish either in open water or in manmade housing.

### SUMMARY

In general, innovative aspects of the subject matter described in this document relate to improving health and well-being of fish in fish pens by using controlled releases of bubbles, e.g., of air, in the vicinity of the fish pen. In aquaculture, storing fish in fish pens can present various issues that can potentially affect the health and well-being of fish. As an example, sounds of predators, machinery, or other noises can induce stress in fish inside a fish pen so that they are less likely to reach optimal growth or health conditions. As another example, predators or other aquatic creatures can encroach upon or invade a fish pen and disrupt or kill fish within. In some cases, varying dissolved oxygen levels in and around fish pens can contribute to elevated stress levels in fish—e.g., as measured by cortisol levels-which can also cause growth or health problems.

Techniques described in this document can be used to address these and potentially other issues associated with aquaculture using sensor-based controlled releases of bubbles. In general, a bubble emission system that generates a bubble curtain around a fish pen can be used as a barrier for incoming sound waves and unwanted marine intruders such as jellyfish and sea lice. Operating such a bubble curtain without an intelligent control mechanism can potentially result in a waste of energy because a bubble curtain may not always be needed to maintain the health and well-being of fish. For example, at a time when there are no disruptive sound sources or potential marine intruders in the vicinity of the fish pen, continuous operation of the bubble emission system (also referred to herein simply as a bubbler) can result in high operating costs with only incremental, if any, advantages. Intelligently controlling a bubble emission system based on inputs from one or more sensors—as described herein—can improve the efficiency of bubblers used in commercial aquaculture, as compared to continuously operating bubblers. Further, the effectiveness, efficiency, and versatility of the bubblers can be potentially improved by taking into account sensor feedback, as compared to bubblers that can only be switched on and off.

The bubbles can be made either partially or entirely of oxygen. The bubbles can be released around a fish pen so as to make a sort of curtain, or the bubbles can be released within the fish pen. This type of bubble curtain may wrap 360 degrees around a fish pen or may block only a portion. The bubbles can be used for, among other purposes, (i) reflecting or dampening sound waves harmful or distressing to fish in a fish pen, (ii) controlling movement of aquatic creatures inside or outside of the fish pen, such as lumpsuckers (including species Cyclopterus lumpus) or jellyfish among others, or (iii) increasing dissolved oxygen levels within the fish pen.

In general, techniques described in this document can improve aquaculture by reducing energy consumption required for generating alleviating bubbles while improving growing efficiency of fish (e.g., decreasing feed requirements while increasing growth) by reducing stress levels in populations. Stress level reduction can also be effective in saving on the use of various treatments, which may be toxic to fish or surrounding wildlife depending on dosage.

By reducing fish stress levels, fish pens can have fish with lower stress levels, that are more efficient in growing, and less likely to contract diseases. The energy used in the bubble generation that reduces stress levels can be minimized using one or more feedback loops to determine a sufficient level of bubble generation that alleviates one or more monitoring conditions or issues in a vicinity of a given fish pen.

In general, one aspect of the subject matter described in this specification can be embodied in methods that include the actions of obtaining sensor data indicating a condition associated with a fish pen; determining that the sensor data satisfies one or more threshold conditions; responsive to determining that the sensor data satisfies one or more threshold conditions, generating at least one signal configured to adjust emission of bubbles from a bubble generation system associated with the fish pen; and adjusting the bubble generation system in accordance with the at least one signal.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. Feature 1: Obtaining sensor data indicating the condition associated with the fish pen can include obtaining sensor data indicating a noise. Feature 2: Obtaining sensor data indicating condition associated with the fish pen can include obtaining sensor data indicating a potential invader of the fish pen. Feature 3: The potential invader of the fish pen can be a jellyfish. Feature 4: Obtaining sensor data indicating the condition associated with the fish pen can include obtaining sensor data indicating a location of a cleaner fish in the fish pen. Feature 5: Actions can include obtaining subsequent sensor data; generating a second signal configured to adjust bubble generation in a vicinity of the fish pen; and transmitting the second signal to the bubble generation system. Feature 6: Obtaining sensor data indicating the condition associated with the fish pen can include obtaining sensor data indicating weather data affecting the vicinity of the fish pen. Feature 7: Obtaining sensor data indicating the condition associated with the fish pen can include obtaining sensor data indicating a level of oxygen dissolved in water in a vicinity of the fish pen. Feature 8: Generating the signal configured to adjust emission of bubbles from the bubble generation system associated with the fish pen can include generating the signal configured to cause bubbles to be generated by the bubble generation system in a ring around the fish pen. Feature 9: Generating the signal configured to adjust emission of bubbles from the bubble generation system associated with the fish pen can include generating the signal configured to cause bubbles to be generated by the bubble generation system in a wall that protects at least a portion of the fish pen.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for controlled use of bubbles in aquaculture.

FIG. 2 is a flow diagram illustrating an example of a process for controlled use of bubbles in aquaculture.

FIG. 3 is a diagram illustrating an example of a computing system used for controlled bubble release in aquaculture.

Like reference numbers and designations in the various drawings indicate like elements.

### DETAILED DESCRIPTION

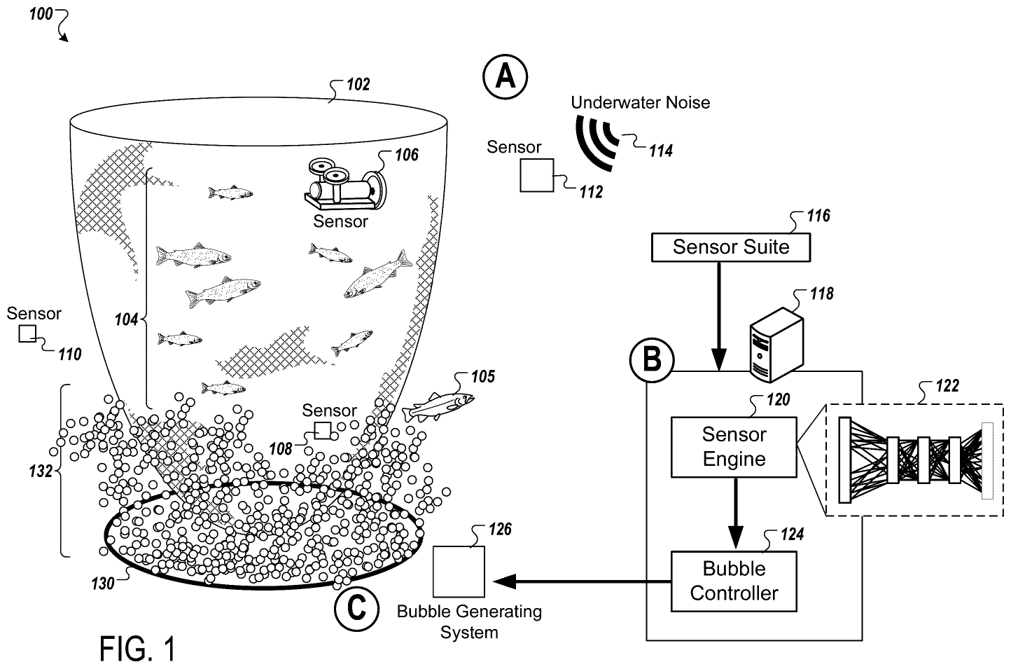

FIG. 1 is a diagram showing an example of a system 100 for controlled use of bubbles in aquaculture. In general, FIG. 1 shows a number of sensors—collectively, sensor suite 116—in and about a fish pen 102 to inform the controlled release of bubbles by a bubble controller 124. The bubble controller 124, along with a sensor engine 120, can be operated by a control unit 118. The bubble controller 124 can operate a bubble generating system 126 that generates bubbles 132 using a bubble dispenser 130.

In stage A, a sensor 112 of the sensor suite 116 detects an underwater noise 114. The underwater noise 114 can be emitted by an aquatic creature—such as a predator of fish 104 stored in the fish pen 102—manmade machinery—such as drills, boats, or the like—among other emitters. The underwater noise 114 can be a type of noise that increases stress levels in the fish 104 of the fish pen 102 which can reduce a feed rate, growth rate, or increase instances of disease in the population of the fish 104.

By alleviating the noise 114, the system 100 can improve the welfare of the fish 104 while increasing the likelihood they survive until harvest and grow to optimal levels without contracting diseases. The system 100 can include the sensor suite 116, the control unit 118, and the bubble generating system 126. By controlling the release of bubbles, the system 100 can help reduce energy use required to operate the bubble generating system 126 while ensuring sufficient bubbles are generated to alleviate issues in the vicinity of the fish pen 102. Issues alleviated by the system 100 can include more than alleviating the noise 114 and can include preventing invaders, such as fish 105, from entering or damaging a net of the fish pen 102, controlling cleaning fish within the fish pen 102 to perform their cleaning duties (e.g., not eating algae off the net but off the fish 104), increasing dissolved oxygen levels in the fish pen 102, among others.

The sensor 112, included in the sensor suite 116, can be communicably connected to the control unit 118. The sensor 112 can provide data indicating the underwater noise 114 to the control unit 118. In some implementations, the sensor 112 is a hydrophone or other sensor configured to detect pressure waves corresponding to sound underwater. In some implementations, the sensor 112 is above water. In some implementations, the sensor 112 is below water.

In some implementations, the control unit 118 obtains other sensor data from the sensor suite 116. The sensor suite 116 can include one or more sensors, such as the sensor 112, sensor 106, sensor 108, and sensor 110. Sensors can include visual sensors, sounds sensors, health sensors, among others. Sensors may be inside 108 or outside the pen 110.

In stage B, the control unit 118 obtains sensor data generated by one or more sensors of the sensor suite 116, such as the sensor 112. The control unit 118 provides the sensor data to the sensor engine 120. The control unit 118 can operate, or be communicably connected to, one or more processors that perform operations described as being performed by the sensor engine 120.

The sensor engine 120 generates output used by the bubble controller 124 to generate a signal for releasing a controlled amount of bubbles in the vicinity of the fish pen 102. In some implementations, the output of the sensor engine 120 includes output from a trained machine learning model. For example, a machine learning model 122 can optionally be used by the sensor engine 120 to process obtained sensor data. The machine learning model can be trained with one or more loss functions or training objectives. The one or more loss functions or training objectives can account for minimizing a stress level of fish, minimizing energy used to generate bubbles by the bubble generating system 126, maximizing growth or feed rates, minimizing future health issues of fish 104 in the fish pen 102, minimizing stress inducing sound in the fish pen 102, among others.

In some implementations, the sensor engine 120 compares one or more values indicating obtained sensor data with one or more values indicating one or more thresholds. For example, the control unit 118 can obtain thresholds indicating various sensor data. The sensor engine 120 can compare one or more values indicating obtained sensor data with the stored threshold to determine whether bubble generation can alleviate an issue in the vicinity of the fish pen 102.

In an example case of underwater noise 114, the sensor engine 120 can obtain sensor data from the sensor 112 indicating the underwater noise 114 and compare values of the underwater noise 114 to one or more threshold values. The threshold values can indicate a minimum threshold noise level above which bubbles are generated at a first rate and below which bubbles are generated at a second rate, where the first rate can be faster or slower than the second rate depending on implementation. The first rate or second rate can be zero, indicating that no bubbles are to be generated.

In some implementations, threshold values depend upon the location of a given sensor. For example, the sensor 110 can include a hydrophone similar to the sensor 112. If the sensor 110 is further from the fish pen 102 than the sensor 112, the sensor engine 120, obtaining information indicating their locations, can adjust a comparison of a threshold for each sensor using the location information. For example, if the sensor 110 is further from the fish pen 102 than the sensor 112, the sensor engine 120 can reduce a noise threshold, or other threshold, for the sensor 110. The sensor engine 120 can adjust output such that, if greater noise is configured to generate greater bubbles, a further away sensor that detects a first level of noise can result in fewer generated bubbles compared to a sensor closer to the fish pen 102 that detects the first level of noise.

In the example of FIG. 1, the sensor engine 120 determines that one or more values of obtained sensor data satisfy one or more thresholds and generates output for the bubble controller 124. The bubble controller 124 generates a signal for the bubble generating system 126 indicating an amount of bubbles to be generated. The signal generated by the bubble controller 124 can include a number of bubbles to be generated within a period of time. The signal can include a general level of bubbles production, such as low, medium, or high. The signal can include a direction of bubble generation.

In some implementations, the bubble generating system 126 includes multiple bubble dispensers in the vicinity of the fish pen 102. For example, the bubble generating system 126 can control bubble dispensers in a ring around the fish pen 102, a curtain on one or more sides of the fish pen 102, one or more bubble dispensers inside the fish pen 102, among others. The signal generated by the bubble controller 124 can indicate which bubble dispenser to dispense bubbles and at what rate or amount.

In some implementations, the bubble controller 124 uses output from the sensor engine 120 to determine which bubble dispenser to dispense bubbles from and a corresponding amount of bubbles to generate. For example, the bubble controller 124 can determine a bubble dispense within the fish pen 102 or directly underneath the fish pen 102 to generate bubbles in a case where obtained sensor data indicates a level of dissolved oxygen in the fish pen 102 below a threshold level. Bubble dispensers directly below the fish pen 102 may be more able to improve oxygen levels in the water of the fish pen 102 compared to bubble dispensers used for bubble curtains.

In the example of FIG. 1, the bubble controller 124 generates a signal to the bubble generating system 126 to generate bubbles at a first rate to help reflect or absorb sound waves of the underwater noise 114. The bubbles 132 are being released by the bubble dispenser 130 and can rise in the water surrounding the fish pen 102 to create a curtain that separates the sound waves of the noise 114 and the fish pen 102 to effectively dampen or remove the stress inducing sound from the fish pen 102.

Although described specifically with respect to releasing bubbles to dampen sound from the underwater noise 114, the system 100 can be used to alleviate other issues described in this document. For example, bubbles can be generated to increase dissolved oxygen levels in the fish pen in response to the sensor engine 120 determining that one or more values indicating a dissolved oxygen sensor reading—e.g., from the sensor 108—satisfies a threshold—e.g., is below a stored value.

In some implementations, the sensor engine 120 compares one or more values of obtained sensor data to one or more thresholds to determine a rate of bubble generation. For example, depending on one or more values of obtained sensor data, the sensor engine 120 can determine if a first threshold or second threshold for a same sensor data type is satisfied. For noise, a first threshold being satisfied can result in a first amount of bubbles being generated, while a second threshold being satisfied can result in a second amount of bubbles being generated, e.g., in a given period of time. In some cases, the first amount can be less or more than the second amount. Greater amount may provide greater levels of alleviation for a given issue.

In some implementations, bubble generation is included in a feedback loop to adjust bubble generation based on observed changes in a given issue. For example, the control unit 118 can obtain subsequent sensor data after determining to generate one or more bubbles for dampening or reflecting sound waves of the underwater noise 114. The subsequent sensor data can indicate whether or not the bubbles were successful.

In some implementations, the control unit 118 increases or decreases bubble generation based on determining one or more values of subsequent sensor data to satisfy one or more thresholds. For example, if subsequent sensor data indicate the sound levels of the underwater noise 114 are still above acceptable levels, the control unit 118 can increase bubble generation, change a location of bubble generation, or perform other alleviation methods, such as increasing oxygen in the fish pen 102 to reduce fish stress levels in spite of noise.

In general, the control unit 118 can seek to minimize bubble generation while providing sufficient alleviation for issues. In this way, the system 100 can help increase fish welfare and improve aquaculture while reducing energy consumption required to operate the bubble generating system 126. In some implementations, one or more machine learning models, e.g., the machine learning model 122, are used to determine a bubble generation output for a given set of input data. A given model can be trained to minimize bubble generation while maximizing welfare of the fish 104.

In general, fish in a marine net pen, such as fish pen 102, may be able to hear sounds in the water; this can include sounds from predators (e.g., whales, seals), heavy underwater construction (e.g., a nearby wind farm installation, drilling or dredging operation), nearby boat engines, or other sound sources that can cause a stress response in fish.

Even though fish are generally safe inside the pen and the predator or startling noise may be miles away, the fish may exhibit stress responses. Their feeding, swimming, and growing patterns may be altered as a response to the predator's noises. This is not only bad for fish welfare, but also bad for the aquaculture industry trying to grow animals sustainably and efficiently.

In general, pens may be fully submerged or partially submerged. Pens can be connected to a water surface, or they can be offshore (e.g., miles away from land). The issues described in this document may be especially important in newer construction far-off shore pens, which can be better than nearshore pens for other sustainability reasons (including less sea lice, less effects on coastal ecosystems, more water exchange, etc.). This type of pen is new because only recently is technology available to run and monitor these pens from afar. Solving challenges like those discussed in this document will be essential to move the industry forward.

In general, a bubble dispenser can include a device that creates bubbles underwater. The gas creating the bubbles will generally float from a given dispenser to the surface. Most commonly bubbles are made of air, although it could be another type of gas too (such as oxygen, nitrogen, or helium). A bubble dispenser 130 may include one or more aerators, oxygenators, gas injectors, air sources, nano bubblers, or bubble curtains.

Offshore construction, such as installation of a wind turbine or oil and gas platform, or seismic surveys, can create loud noises underwater that affect marine life. Some marine life is more sensitive to sound and other pressure waves than humans, so technology sensors can be used to detect the threat and provide for alleviation as described in this document.

In general, a bubble dispensing device, such as the bubble generating system 126, can be controlled using information from aquaculture monitoring systems or sensors, such as the sensor suite 116 monitoring the fish pen 102. Signals from aquaculture monitoring sensors (such as hydrophone, cameras, lasers, biochemical sensors, and other sensors) can be sent to the control unit 118. The control unit 118 can decide when to turn on or off the bubble generating system 126 based on potential stress signals from the fish or detected issues in the vicinity of the fish pen 102.

The control unit 118 can modify a position, shape, type or velocity of bubbles for a desired effect, such as alleviating one or more issues discussed in this document. A bubble dispenser, sensors, and controller can be in a feedback loop optimized for maximum fish welfare or energy efficiency among other objectives. In reference to FIG. 1, a feedback loop can include the sensor suite 116, the control unit 118, and the bubble generating system 126.

In some implementations, a bubble dispensing device is situated below the fish pen 102. A bubble dispenser, such as the dispenser 130, can generate a bubble curtain around the fish pen 102. A location, shape, size, or velocity of bubbles can be controlled by the control unit 118 based on information from sensors in the sensor suite 116 monitoring the fish pen 102. For example, if a hydrophone in the fish pen, such as the sensor 108, detects predator notices (such as sounds from nearby offshore operation), the signal can be processed by the control unit 118 and used to generate a signal to activate a bubble curtain to shield fish from the noise.

The system 100 may monitor fish and control bubble generation based on patterns or behaviors of the fish 104. For example, the control unit 118 can obtain sensor data that indicates that fish 104 are schooling, swimming, or eating normally (e.g., as determined by a machine learning model trained to detect abnormal or normal behaviors or conditions in fish pens). If sensor data does not indicate normal schooling or swimming behavior, the system 100 can try a different type of bubble curtain or alert a user or relevant authorities. A direction or size of bubbles can be determined by a type and direction of current or sound source.

One example of a dispenser can include a tube, either curved or straight, with openings to allow air pumped into the dispenser to leave through the holes and float up to a water surface.

Techniques described in this document can be used in a wide variety of situations. For example, techniques can be used in offshore fish pens, near-shore fish pens, fully or partially submerged pens, among others.

In some implementations, some sounds or signals are pre-classified as dangerous for fish. For example, the control unit 118 can compare sensor data indicating sound and compare the sound to one or more profiles of sound pre-classified as dangerous for fish. In response to determining one or more detected sounds that are dangerous for fish, the control unit 118 can generate a signal for the bubble generating system 126 to generate bubbles—e.g., generate a bubble curtain for reflecting or absorbing sound waves.

For example, the following stress-inducing sounds could cause damage to fish: nearby loud offshore construction noises (such as installation of a wind farm), engine noises from nearby boats, whale calls, or sounds from natural marine predators.

The following issues can also be mitigated by controlled generation of bubbles: detected incoming jellyfish, ectoparasites (such as sea lice), invading marine life, or other threats detected by biological or camera sensors, low dissolved oxygen (detected by dissolved oxygen sensor), detected anomalies or stress signals in the fish (such as fish swimming or schooling patterns being interrupted, their growth or eating patterns changing, or their levels or cortisol rising).

For bubble generation without a known cause except for detected change of behaviors in a fish population, such as the fish 104, bubble generation may be beneficial even if an issue external to the fish is not detected. For example, a sound may not be perceptible by sensing equipment due to sensitivity, sensor impairment, frequency response, among other conditions. In general, bubble generation may be calming for fish and may be used generally to alleviate stress in fish that exhibit signs of being stressed. Such signs can include changes in eating, swimming or schooling, growth patterns, disease rate, among others.

In some implementations, the control unit 118 provides signals indicating preset patterns for bubble generation. For example, the control unit 118 can access one or more pre-set bubble patterns to deploy by sending a signal indicating the pattern (e.g., rate, amount, timing, among others) to the bubble generating system 126. In some implementations, the control unit 118 can use a machine learning algorithm to optimize bubble patterns based on desired output (such as lower lice, less jellyfish, or better fish schooling behaviors). It can be possible that bubbles are generated only on one side, or in one area, of the fish pen 102, e.g., if there are heavy currents and the threat is only from one side or a given area.

In general, it may be undesirable to continuously run the bubble generating system 126 to generate bubbles because the mechanical system may need downtime. It could also restrict flow of fresh water, draw too much energy, or cause other disturbances. Hence, the system 100 can reduce the amount of up time for bubble generation of the bubble generating system 126.

Using a bubble dispenser for neutralizing predatory sounds, or other sounds that induce fish stress, can have several benefits to the fish 104 in the fish pen 102.

In some implementations, the sensor suite 116 detects cleaner fish in the fish pen 102 and the control unit 118 uses sensor data indicating cleaner fish in the fish pen 102 to adjust bubble generation. For example, if cleaner fish (such as lumpsuckers) are detected by one or more sensors of the sensor suite 116 to be eating more algae from the net than lice off fish (or more than a certain threshold amount of time eating algae of a net), then the control unit 118 can generate bubbles using the bubble generating system 126 to move the cleaner fish away from the net and towards a center of the fish pen 102 or to another location, e.g., where there are fish.

In some implementations, the control unit 118 generates bubbles to oxygenate water in the vicinity of the fish pen 102. For example, bubbles can be used to oxygenate water to remedy cases of low oxygen. Low oxygen can result from biological die offs at or near the fish pen 102. In some implementations, the sensor suite 116 can include one or more sensors away from the fish pen 102 to preemptively detect low oxygen water moving towards a vicinity of the fish pen 102. Obtaining this sensor data, the control unit 118 can generate, or prepare to generate bubbles to counteract any negative consequences of exposing the fish 104 to low oxygen levels from the low oxygen water moving towards the vicinity of the fish pen 102.

In some implementations, the control unit 118 generates bubbles as a barrier to keep out marine organisms. For example, the control unit 118 can generate bubbles to form a barrier to help keep out floating organisms such as sea lice or other parasites, larvae, or jellyfish. In some implementations, sensor data obtained by the sensor suite 116 can include data indicating an invading organism, such as another fish, parasite, jellyfish, among others. For example, a visual sensor can obtain an image of an invader within determined distance from the fish pen 102. The control unit 118 can detect the invader within the determined distance and send a signal to the bubble generating system 126 configured to cause the bubble generating system 126 to generate bubbles at a location of the invader or at a predicting future location of the invader to effectively scare away the invader and prevent the invader from invading the fish pen 102, killing any of the fish 104, infecting any of the fish 104, or damaging or latching onto a net of the fish pen 102.

In some implementations, the control unit 118 can generate bubbles preemptively. For example, if sounds, e.g., by manmade construction, are planned for a given day or time, the control unit 118 can prepare or send a signal to the bubble generating system 126 to generate bubbles so that bubbles are generated in time to alleviate the scheduled sounds. Information regarding scheduled sounds can be provided by a user device communicably connected to the control unit 118 or via the Internet.

In some implementations, the control unit 118 can access weather data to inform bubble generation. For example, the control unit 118 can access weather data indicating currents or other weather affecting water in the vicinity of the fish pen 102. Using the weather data, the control unit 118 can instigate or adjust bubble generation. In some implementations, weather data is used to adjust a location of the bubbles to account for current shifts.

FIG. 1 is described in reference to stages—e.g., A, B, and C—for ease of description but the order of such stages or their description should not be construed to limit other potential orderings of processes described in reference to FIG. 1.

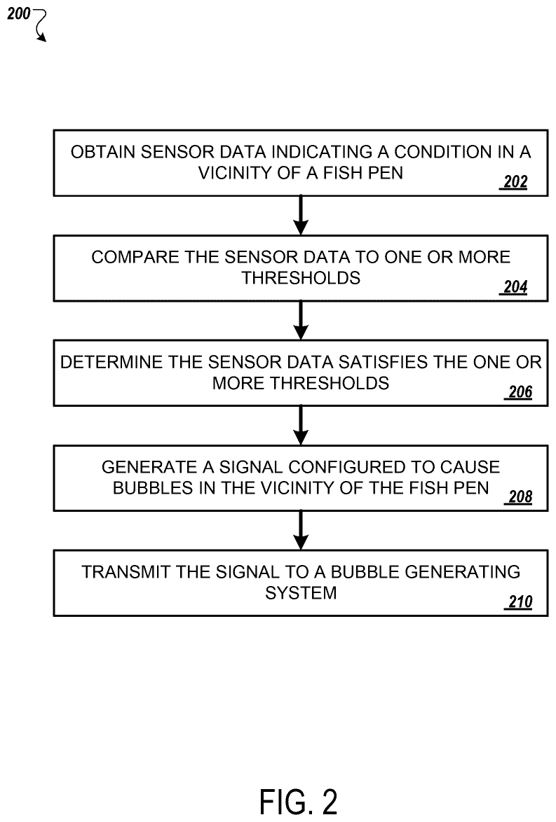

FIG. 2 is a flow diagram illustrating an example of a process 200 for controlled use of bubbles in aquaculture. The process 200 may be performed by one or more electronic systems, for example, the system 100 of FIG. 1.

The process 200 includes obtaining sensor data indicating a condition in a vicinity of a fish pen (202). For example, the control unit 118 can obtain sensor data indicating the noise 114, an invader 105, or low oxygen levels. Sensor data indicating an invader, such as the fish 105, can be obtained from a visual sensor or camera, such as the sensor 106. Sensor data indicating low oxygen levels can be obtained from an oxygen level sensor, such as the sensor 108.

The sensor 106, or other sensors of the sensor suite 116 can be mobile. In some implementations, sensor locations are controlled by the control unit 118. For example, the control unit 118 can control sensor locations to monitor one or more issues in the vicinity of the fish pen 102 or to monitor a response of the fish in response to actions for alleviating an issue.

The process 200 includes comparing the sensor data to one or more thresholds (204). For example, the control unit 118 can compare sensor data obtained from the sensor suite 116 to one or more thresholds. Each of the one or more thresholds can be associated with corresponding bubble generation. Sensor data satisfying a first threshold can result in a determined amount or type of bubble generation. Sensor data satisfying a second threshold can result in a different determined amount or type of bubble generation in the vicinity of the fish pen 102. Thresholds can include a distance of an invader to the fish pen 102, a decibel value or other value indicating noise level, an oxygen level, a location or time of a cleaner fish in relation to an area of the fish pen 102, among others.

The process 200 includes determining the sensor data that satisfies the one or more thresholds (206). For example, the control unit 118 can determine that the noise 114 satisfies a sound threshold. The control unit 118 can compare one or more values representing a level of the noise 114 to one or more values representing thresholds of acceptable or not acceptable noise in the vicinity of the fish pen 102. The sensor data can satisfy a given threshold when values of the sensor data meet or exceed or fall short of values representing the threshold.

The process 200 includes generating a signal configured to cause bubbles in the vicinity of the fish pen (208). For example, the bubble controller 124, controlled by the control unit 118, can generate a signal. The signal can be configured to generate a particular amount or type of bubble. The signal can be configured to cause one or more elements of the bubble generating system 126 to generate bubbles in a particular way. The elements of the bubble generating system 126 can include a pump to pump air through openings of a dispenser connected to the bubble generating system 126.

The process 200 includes transmitting the signal to a bubble generating system (210). For example, the control unit 118 can transmit a signal to the bubble generating system 126. The signal can be configured to cause the bubble generating system 126 to generate the bubbles 132 using the dispenser 130. In general, depending on sensor data obtained from the sensor suite 116, the control unit 118 can instigate or adjust generation of bubbles in the vicinity of the fish pen 102. Sensor data can include visual data of the fish 104 swimming or schooling.

In some implementations, the process 200 includes adjusting the bubble generation system in accordance with at least one signal. For example, the control unit 118 can adjust the release of the bubbles 132 by the bubble generating system 126 by transmitting one or more signals to the bubble generating system 126. The one or more signals transmitted by the control unit 118 can be configured to adjust emission of bubbles from a bubble generation system associated with a given fish pen.

In some implementations, the machine learning model 122 is used by the control unit 118 to process one or more values of sensor data obtained from the sensor suite 116. For example, the machine learning model 122 can be used to determine if schooling or swimming patterns of the fish 104 match known patterns or swimming styles of fish under stress. Even in the absence of direct detected threats, such as noise, invaders, or low oxygen, the control unit 118 can generate signals to cause the generation of bubbles in the vicinity of the fish pen 102, e.g., to alleviate detected stress levels in the fish 104. Stress levels can be detected directly using biological sensors—e.g., cortisol levels—or indirectly using school, swimming, eating, or growth behaviors, among others.

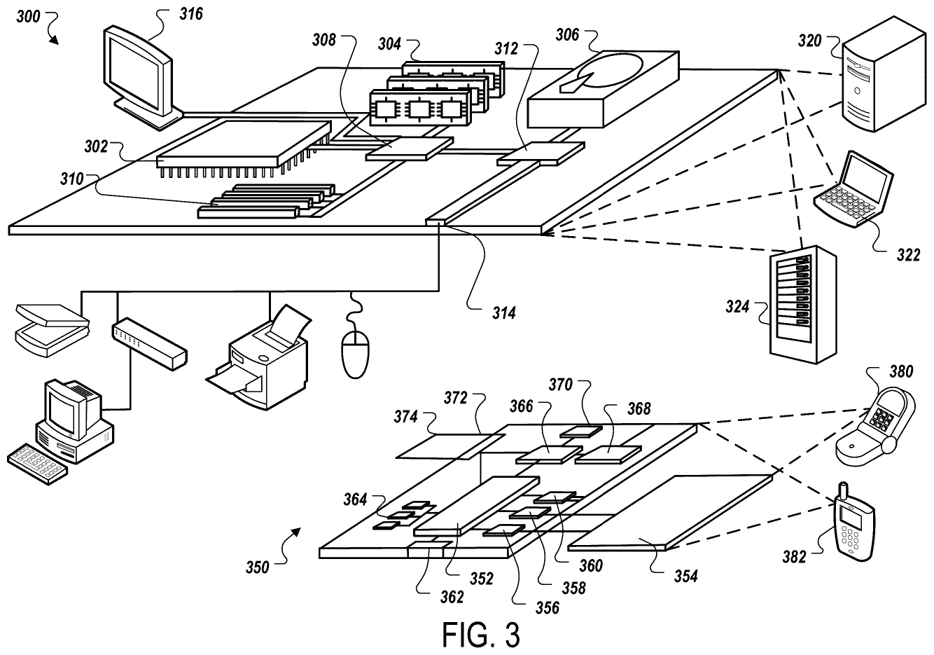

FIG. 3 is a diagram illustrating an example of a computing system used for controlled bubble release in aquaculture. The computing system includes computing device 300 and a mobile computing device 350 that can be used to implement the techniques described herein. For example, one or more components of the system 100 could be an example of the computing device 300 or the mobile computing device 350, such as a computer system implementing the control unit 118, devices that access information from the control unit 118, or a server that accesses or stores information regarding the operations performed by the control unit 118.

The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 302 is a single threaded processor. In some implementations, the processor 302 is a multi-threaded processor. In some implementations, the processor 302 is a quantum computer.

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine readable mediums (for example, the memory 304, the storage device 306, or memory on the processor 302). The high-speed interface 308 manages bandwidth-intensive operations for the computing device 300, while the low-speed interface 312 manages lower bandwidth-intensive operations. Such allocation of functions is an example only. In some implementations, the high speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device, such as a mobile computing device 350. Each of such devices may include one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provided as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry in some cases. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 368 using a radio frequency. In addition, short-range communication may occur, such as using a Bluetooth, Wi-Fi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, among others) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method comprising:
obtaining sensor data indicating a condition associated with a fish pen;
determining that the sensor data satisfies one or more threshold conditions;
responsive to determining that the sensor data satisfies one or more threshold conditions, generating at least one signal configured to adjust emission of bubbles from a bubble generation system associated with the fish pen; and
adjusting the bubble generation system in accordance with the at least one signal.

2. The method of claim 1, wherein obtaining sensor data indicating the condition associated with the fish pen comprises:
obtaining sensor data indicating a noise.

3. The method of claim 1, wherein obtaining sensor data indicating condition associated with the fish pen comprises:
obtaining sensor data indicating a potential invader of the fish pen.

4. The method of claim 3, wherein the potential invader of the fish pen is a jellyfish.

5. The method of claim 1, wherein obtaining sensor data indicating the condition associated with the fish pen comprises:
obtaining sensor data indicating a location of a cleaner fish in the fish pen.

6. The method of claim 1, comprising:
obtaining subsequent sensor data;
generating a second signal configured to adjust bubble generation in a vicinity of the fish pen; and
transmitting the second signal to the bubble generation system.

7. The method of claim 1, wherein obtaining sensor data indicating the condition associated with the fish pen comprises:
obtaining sensor data indicating weather data affecting the vicinity of the fish pen.

8. The method of claim 1, wherein obtaining sensor data indicating the condition associated with the fish pen comprises:
obtaining sensor data indicating a level of oxygen dissolved in water in a vicinity of the fish pen.

9. The method of claim 1, wherein generating the signal configured to adjust emission of bubbles from the bubble generation system associated with the fish pen comprises:
generating the signal configured to cause bubbles to be generated by the bubble generation system in a ring around the fish pen.

10. The method of claim 1, wherein generating the signal configured to adjust emission of bubbles from the bubble generation system associated with the fish pen comprises:
generating the signal configured to cause bubbles to be generated by the bubble generation system in a wall that protects at least a portion of the fish pen.

11. One or more non-transitory computer storage media encoded with computer program instructions that when executed by one or more computers cause the one or more computers to perform operations comprising:
obtaining sensor data indicating a condition associated with a fish pen;
determining that the sensor data satisfies one or more threshold conditions;
responsive to determining that the sensor data satisfies one or more threshold conditions, generating at least one signal configured to adjust emission of bubbles from a bubble generation system associated with the fish pen; and
adjusting the bubble generation system in accordance with the at least one signal.

12. The media of claim 11, wherein obtaining sensor data indicating the condition associated with the fish pen comprises:
obtaining sensor data indicating a noise.

13. The media of claim 11, wherein obtaining sensor data indicating condition associated with the fish pen comprises:
obtaining sensor data indicating a potential invader of the fish pen.

14. The media of claim 13, wherein the potential invader of the fish pen is a jellyfish.

15. The media of claim 11, wherein obtaining sensor data indicating the condition associated with the fish pen comprises:
obtaining sensor data indicating a location of a cleaner fish in the fish pen.

16. The media of claim 11, wherein the operations comprise:
obtaining subsequent sensor data;
generating a second signal configured to adjust bubble generation in a vicinity of the fish pen; and
transmitting the second signal to the bubble generation system.

17. The media of claim 11, wherein obtaining sensor data indicating the condition associated with the fish pen comprises:
obtaining sensor data indicating weather data affecting the vicinity of the fish pen.

18. The media of claim 11, wherein obtaining sensor data indicating the condition associated with the fish pen comprises:
obtaining sensor data indicating a level of oxygen dissolved in water in a vicinity of the fish pen.

19. The media of claim 11, wherein generating the signal configured to adjust emission of bubbles from the bubble generation system associated with the fish pen comprises:
generating the signal configured to cause bubbles to be generated by the bubble generation system in a ring around the fish pen.

20. A system comprising:
one or more computers and one or more storage devices on which are stored instructions that are operable, when executed by the one or more computers, to cause the one or more computers to perform operations comprising:
obtaining sensor data indicating a condition associated with a fish pen;
determining that the sensor data satisfies one or more threshold conditions;
responsive to determining that the sensor data satisfies one or more threshold conditions, generating at least one signal configured to adjust emission of bubbles from a bubble generation system associated with the fish pen; and
adjusting the bubble generation system in accordance with the at least one signal.
